(19) United States
(12) Patent Application Publication
(10) Pub. No.: US 2025/0309272 A1
(43) Pub. Date: Oct. 2, 2025

(54) NEGATIVE ELECTRODE PLATE, ELECTROCHEMICAL DEVICE, AND ELECTRONIC DEVICE

(71) Applicant: Ningde Amperex Technology Limited, Ningde City, Fujian Province (CN)

(72) Inventors: Dongdong Han, Ningde City (CN); Xiaoqian Liu, Ningde City (CN)

(73) Assignee: Ningde Amperex Technology Limited, Ningde City, Fujian Province (CN)

(21) Appl. No.: 19/095,415

(22) Filed: Mar. 31, 2025

(30) Foreign Application Priority Data
Mar. 31, 2024 (CN) 202410383430.X

(51) Int. Cl. H01M 4/62; H01M 4/02; H01M 4/133; H01M 4/48; H01M 4/587

(52) U.S. Cl. CPC H01M 4/625; H01M 4/133; H01M 4/48; H01M 4/587; H01M 4/622; H01M 2004/021; H01M 2004/027

(57) ABSTRACT

A negative active material layer of the negative electrode plate includes a negative active material and a functional material. The functional material is distributed between particles of the negative active material. The functional material includes a conductive carbon fiber tube and a linear binder adsorbed on the surface of the conductive carbon fiber tube. The length of the conductive carbon fiber tube is L1, and L1 satisfies: 2 μm≤L1≤50 μm. Three points on the same conductive carbon fiber tube along the length direction of the conductive carbon fiber tube are consecutively selected and connected into a polyline to form a first angle α at a middle point of the three points as a vertex, satisfying: 30°≤α≤180°.

### CROSS-REFERENCE TO RELATED APPLICATIONS

The present application claims priority to Chinese Patent Application No. 202410383430.X, filed on Mar. 31, 2024, the disclosure of which is hereby incorporated by reference in its entirety.

### TECHNICAL FIELD

This application relates to the technical field of electrochemical devices, and in particular, to a negative electrode plate, an electrochemical device, and electronic device.

### BACKGROUND

Electrochemical devices represented by a lithium-ion battery are distinctly characterized by a high energy density, a long cycle life, little pollution, no memory effect, and the like. As clean energy, the electrochemical devices have been progressively applied to a wide range of fields from electronic products to large-sized devices such as an electric vehicle to meet the strategy of sustainable development of the environment and energy.

With respect to the negative electrode of an electrochemical device, a negative active material layer is connected to the surface of a negative current collector. The negative active material layer is prone to active material detachment caused by cold pressing. The active material detachment affects the stability of the negative active material layer, and in turn, reduces the kinetic performance of the electrochemical device.

### SUMMARY

Some embodiments of this application provide a negative electrode plate, an electrochemical device, and an electronic device, and can improve the charge rate performance of the electrochemical device by improving the stability of the negative electrode plate.

According to a first aspect, an embodiment of this application provides a negative electrode plate. The negative electrode plate includes a negative active material layer.

The negative active material layer includes a negative active material and a functional material. The functional material is distributed between particles of the negative active material. The functional material includes a conductive carbon fiber tube and a linear binder. The linear binder is adsorbed on a surface of the conductive carbon fiber tube. The length of the conductive carbon fiber tube is L1, and L1 satisfies: 2 μm≤L1≤50 μm. Three points on the same conductive carbon fiber tube along the length direction of the conductive carbon fiber tube are arbitrarily selected and connected into a polyline to form a first angle α at a middle point of the three points as a vertex, satisfying: 30°≤α≤180°. The middle point is a point located in the middle along the length direction.

In some exemplary embodiments, 2 μm≤L1≤30 μm, and 80°≤α≤180°.

In some exemplary embodiments, the conductive carbon fiber tube satisfies at least one of the following conditions:
an outer diameter of the conductive carbon fiber tube is D1, and D1 satisfies: 30 nm≤D1≤130 nm;
an inner diameter of the conductive carbon fiber tube is D2, and D2 satisfies: 1 nm≤D2≤30 nm;
a gravimetric capacity of the conductive carbon fiber tube is S, and S satisfies: 120 mAh/g≤S≤300 mAh/g; or a resistivity of the conductive carbon fiber tube is ρ, and ρ satisfies: 5 mΩ·cm≤ρ≤30 mΩ·cm.

In some exemplary embodiments, particle diameters of the negative active material include Dᵥ₁₀, and the negative active material layer satisfies at least one of the following conditions:

$$\begin{matrix}2 μm \leq {D}_{v 10} \leq 9 μm ; or \\ 0.8 \leq L 1 / {D}_{v 10} \leq 6 .\end{matrix}$$

In some exemplary embodiments, based on a mass of the negative active material layer, the mass percentage of the negative active material is A, the mass percentage of the conductive carbon fiber tube is B, and the mass percentage of the linear binder is C; and the negative active material layer satisfies at least one of the following conditions:

$$\begin{matrix}94. \% \leq A \leq 98.6 \% ; \\ 0.1 \% \leq B \leq 3. \% ; \\ 0.5 \% \leq C \leq 3. \% ; or \\ 0.1 \leq B / C \leq 1.5 .\end{matrix}$$

In some exemplary embodiments, the weight-average molecular weight of the linear binder is M_{w}, and M_{w} satisfies: 8×10⁵≤M_{w}≤25×10⁵.

In some exemplary embodiments, the linear binder is at least one selected from the group consisting of a carboxymethyl cellulose salt, polyacrylic acid, a polyacrylate salt, a polyacrylate ester, and polyimide.

The negative active material is at least one selected from the group consisting of graphite, hard carbon, and a silicon-containing active material.

In some exemplary embodiments, the negative active material layer further includes a particulate binder. The particulate binder is bonded to the negative active material and the functional material.

The particulate binder is at least one selected from the group consisting of styrene-butadiene rubber and poly(styrene-co-butadiene).

Based on a mass of the negative active material layer, a mass percentage of the particulate binder is E, and E satisfies: 0%<E≤2.0%.

In some exemplary embodiments, the negative electrode plate further includes a negative current collector, and the negative active material layer is connected to a surface of the negative current collector.

A pressure resistance F1 exists between the negative active material layer and the negative current collector, and F1 satisfies: 30 kg/m≤F1≤90 kg/m; and

The negative active material layer possesses a cohesive force F2, and F2 satisfies:

$$15 N / m \leq F 2 \leq 60 N / m .$$

According to a second aspect, this application provides an electrochemical device, including the negative electrode plate described above.

According to a third aspect, this application provides an electronic device, including the electrochemical device described above.

Based on the negative electrode plate, electrochemical device, and electronic device disclosed herein, the linear binder is adsorbed on the surface of the conductive carbon fiber tube, and the linear binder can also bond to other materials in the negative active material layer, thereby increasing the cohesive force in the negative active material layer and alleviating the problem of easy detachment of the active material from the negative active material layer. In addition, when the negative active material layer assumes a tendency to expand or expands, the linear binder can still play a good bonding role, buffer the expansion stress, and make the negative active material layer less prone to shed powder of the active material. The linear binder is connected to the conductive carbon fiber tube and other materials in the negative active material layer, thereby being conducive to maintaining the stability of the three-dimensional conductive network. In this way, when applied in the electrochemical device, the negative electrode plate improves the charge-and-discharge rate performance, the cycle capacity retention rate, and other kinetic performance metrics of the electrochemical device.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below are merely a part of embodiments of this application. A person skilled in the art may derive other drawings from such drawings without making any creative effort.

FIG. 1 is a schematic structural diagram of material distribution of a negative active material layer according to an embodiment of this application.

### LIST OF REFERENCE NUMERALS

10. negative active material; 20. conductive carbon fiber tube; 30. linear binder; 40. particulate binder.

### DETAILED DESCRIPTION

The following describes in detail some embodiments of an electrochemical device and an electronic device according to this application with reference to drawings. However, unnecessary details may be omitted in some cases. For example, a detailed description of a well-known matter or repeated description of an essentially identical structure may be omitted. That is intended to prevent the following descriptions from becoming unnecessarily lengthy, and to facilitate understanding by a person skilled in the art. In addition, the following descriptions are intended for a person skilled in the art to thoroughly understand this application, but not intended to limit the subject-matter set forth in the claims.

A “range” disclosed herein is defined in the form of a lower limit and an upper limit. A given range is defined by a lower limit and an upper limit selected. The selected lower and upper limits define the boundaries of a particular range. A lower limit of one range may be arbitrarily combined with an upper limit of another range to form a range.

Unless otherwise expressly specified herein, any embodiments and optional embodiments hereof may be combined with each other to form a new technical solution.

Unless otherwise expressly specified herein, “include” and “comprise” mentioned herein mean open-ended inclusion, or closed-ended inclusion. For example, the terms “include” and “comprise” may mean inclusion of other items that are not recited, or inclusion of only the items recited.

Unless otherwise expressly specified, the term “or” used herein is inclusive. For example, the expression “A or B” means “A alone, B alone, or both A and B”. More specifically, all and any of the following conditions satisfy the condition “A or B”: A is true (or existent) and B is false (or absent); A is false (or absent) and B is true (or existent); and, both A and B are true (or existent).

The applicant hereof finds that with respect to the negative electrode plate of an electrochemical device, a negative active material layer is connected to the surface of a negative current collector. When the interaction force between the materials inside the negative active material layer is insufficient, the problem of detachment of the active material tends to occur under the action of an external force. In view of this problem, some embodiments of this application provide a negative electrode plate, an electrochemical device, and an electronic device, and can improve the stability of the negative electrode plate, thereby improving the kinetic performance of the electrochemical device.

The negative electrode plate provided in an embodiment of this application includes a negative active material layer. The negative active material layer includes a negative active material and a functional material.

The negative active material is capable of retain and release metal ions. The negative active material is at least one selected from the group consisting of graphite, hard carbon, and a silicon-containing active material. The silicon-containing active material is at least one selected from the group consisting of silicon carbide and silicon oxide.

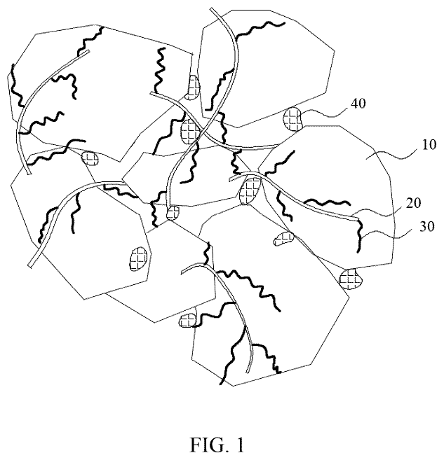

As shown in FIG. 1, the functional material is distributed between the particles of the negative active material 10. The functional material includes a conductive carbon fiber tube 20. The conductive carbon fiber tube 20 is in the shape of a rod that is long and straight or curved to a degree. Each conductive carbon fiber tube 20 is not self-entangled. Adjacent conductive carbon fiber tubes 20 are not entangled with each other. The conductive carbon fiber tubes 20 construct a three-dimensional conductive network to improve the conductivity of the negative active material layer, thereby improving the kinetic performance of the electrochemical device. The conductive carbon fiber tube 20 is of a specified length, and can increase the probability of contact with other conductive substances, thereby further reducing the internal resistance of the negative active material layer.

The non-entangled state of the conductive carbon fiber tube 20 is: three points on the same conductive carbon fiber tube 20 along the length direction of the tube are selected consecutively and connected into a polyline to form a first angle α at a middle point as a vertex, satisfying: 30°≤α≤180°. For example, the conductive carbon fiber tube 20 is long and straight or somewhat curved or in other shapes. The conductive carbon fiber tube 20 in a stretched state is selected so that the conductive carbon fiber tube 20 is more capable of implementing conduction between two conductive materials that are far apart, gives full play to the long-range conductive effect, and is more available for adsorbing or attaching other substances, thereby improving the cohesive force of the negative active material layer. When a is less than 30°, the conductive carbon fiber tube 20 is largely curved, and is prone to be entangled in the negative active material layer. Even when the length of the conductive carbon fiber tube 20 is extended, the long-range conductive effect of the conductive carbon fiber tube is not fully exerted, thereby being adverse to alleviating the internal resistance of the negative electrode plate. In addition, when a is less than 30°, the linear binder (to be described below) connected to the conductive carbon fiber tube 20 fails to be stretched, thereby resulting in failure of the linear binder to connect to more materials, and in turn, leading to a decrease in the cohesive force in the negative active material layer. When applied in an electrochemical device, the negative electrode plate is hardly effective in alleviating the thickness expansion rate of the electrochemical device. Further, 80°≤α≥180°. In this case, the conductive carbon fiber tube 20 is more stretched, thereby more significantly implementing conduction between two conductive materials that are far apart, and giving full play to the long-range conductive effect.

The length of the conductive carbon fiber tube 20 is L1, and L1 satisfies: 2 μm≤L1≤50 μm. For example, L1 may be 3 μm, 10 μm, 15 μm, 20 μm, 30 μm, 50 μm, or a value falling within a range formed by any two thereof. When L1 satisfies 2 μm≤L1≤50 μm, the conductive network in the negative active material layer can form a three-dimensional conductive network with a stable and uniform spatial distribution. When L1 is lower than 3 μm as a lower limit, the conductive carbon fiber tube 20 is excessively short, and the probability of each conductive carbon fiber tube 20 contacting other conductive materials is reduced, thereby being adverse to improving the conductivity of the negative electrode plate. When L2 is higher than 30 μm as an upper limit, the conductive carbon fiber tube 20 is excessively long and hardly dispersible. Consequently, the conductive carbon fiber tube 20 is prone to crosslinking and entangling, and the distribution of conductivity in the negative electrode material layer is nonuniform, thereby being adverse to ion transmission. Further, 2 μm≤L1≤ 30 μm. In this case, the conductive carbon fiber tube 20 is more dispersible, thereby reducing the probability of crosslinking and entangling of the conductive carbon fiber tubes, and further improving the uniformity of distribution of the conductive carbon fiber tubes in the negative electrode material layer.

The functional material further includes a linear binder 30. As shown in FIG. 1, the linear binder 30 is adsorbed on the surface of the conductive carbon fiber tube 20, and the linear binder 30 can also bond to other materials in the negative active material layer, thereby increasing the cohesive force in the negative active material layer and alleviating the problem of easy detachment of the active material from the negative active material layer. In addition, when the negative active material layer assumes a tendency to expand or expands, the linear binder 30 can still play a good bonding role, buffer the expansion stress, and make the negative active material layer less prone to shed powder of the active material. The linear binder 30 is connected to the conductive carbon fiber tube 20 and other materials in the negative active material layer, thereby being conducive to maintaining the stability of the three-dimensional conductive network. In this way, when applied in the electrochemical device, the negative electrode plate improves the charge-and-discharge rate performance, the cycle capacity retention rate, and other kinetic performance metrics of the electrochemical device.

The conductive carbon fiber tube 20 assumes a hollow structure, so that the specific surface area of the conductive carbon fiber tube 20 is relatively large, thereby improving the electron and ion transmission performance in the negative active material layer, and in turn, improving the discharge performance of the electrochemical device. With the conductive carbon fiber tube 20 being a hollow structure, the stress is reduced when the electrode plate is bent and deformed during the compaction of the electrode plate, thereby avoiding fracture of the electrode plate.

In some exemplary embodiments, the outer diameter of the conductive carbon fiber tube 20 is D1, and D1 satisfies: 30 μm≤D1≤130 μm. For example, D1 may be 30 nm, 40 nm, 70 nm, 100 nm, 130 nm, or a value falling within a range formed by any two thereof. With the outer diameter D1 of the conductive carbon fiber tube 20 falling within the range of 30 nm≤ D1≤130 nm, the outer diameter of the conductive carbon fiber tube 20 is suitable, thereby exerting good conductivity and reducing the resistance of the negative electrode plate. When the outer diameter D1 of the conductive carbon fiber tube 20 is lower than 30 nm as a lower limit, the stiffness of the conductive fiber is reduced, and the conductive fiber is prone to entangle, thereby reducing the effect of long-range conduction. When the outer diameter D1 of the conductive carbon fiber tube 20 is higher than 130 nm as an upper limit, the number of conductive fibers is reduced if the total weight remains constant, thereby reducing the density of the conductive network, and deteriorating the performance of the electrode plate.

In some exemplary embodiments, the inner diameter of the conductive carbon fiber tube 20 is D2, and D2 satisfies: 1 μm≤D2≤30 μm. For example, D2 may be 1 nm, 5 nm, 10 nm, 20 nm, 30 nm, or a value falling within a range formed by any two thereof. With the inner diameter D2 of the conductive carbon fiber tube 20 falling within the range of 1 nm≤D2≤30 nm, the wall thickness of the conductive carbon fiber tube 20 is in an appropriate range, thereby facilitating the migration of ions inside the conductive carbon fiber tube 20, making the conductive carbon fiber tube 20 highly conductive, and making the impedance of the negative active material layer fall within an appropriate range. When D2 is higher than 30 nm as an upper limit, the internal space of the conductive carbon fiber tube 20 is excessively large, the impedance of the conductive carbon fiber tube 20 is large, the conductive carbon fiber tube 20 is prone to fracture, and it is difficult to produce a relatively long conductive carbon fiber tube 20.

In some exemplary embodiments, the resistivity of the conductive carbon fiber tube 20 is ρ, and ρ satisfies: 5 mΩ·cm≤ρ≤30 mΩ·cm. For example, ρ may be 5 mΩ·cm, 15 mΩ·cm, 20 mΩ·cm, 25 mΩ·cm, 30 mΩ·cm, or a value falling within a range formed by any two thereof. With the resistivity ρ of the conductive carbon fiber tube 20 falling within the range of 5 mΩ·cm≤ρ≤30 mΩ·cm, the conductive carbon fiber tube 20 can exert high conductivity in the case of both long-range conduction and short-range conduction, thereby being conducive to constructing a three-dimensional conductive network.

The gravimetric capacity of the conductive carbon fiber tube 20 means a ratio of the electrical capacity releasable from the conductive carbon fiber tube 20 to the mass of the conductive carbon fiber tube 20. In some exemplary embodiments, the gravimetric capacity of the conductive carbon fiber tube 20 is S, and S satisfies: 120 mAh/g≤S≤300 mAh/g. For example, S may be 120 mAh/g, 140 mAh/g, 180 mAh/g, 200 mAh/g, 250 mAh/g, or a value falling within a range formed by any two thereof. With the gravimetric capacity S of the conductive carbon fiber tube 20 falling within the range of 120 mAh/g≤S≤300 mAh/g, the conductive carbon fiber tube 20 exhibits high conductivity. In addition, when applied in an electrochemical device, the negative electrode plate endows the electrochemical device with a higher energy density. When the gravimetric capacity S of the conductive carbon fiber tube 20 is lower than 120 mAh/g as a lower limit, the conductivity of the conductive fiber of the conductive carbon fiber tube 20 is excessively low, thereby being adverse to lithiation and resulting in a decrease in the energy density. When the gravimetric capacity S of the conductive carbon fiber tube 20 is higher than 250 mAh/g as an upper limit, the conductive carbon fiber tube 20 is required to be graphitized to a higher degree, thereby causing the conductive carbon fiber tube 20 to become brittle and easily breakable during production, and making it difficult for the conductive carbon fiber tube to achieve the desired length.

In some exemplary embodiments, the particle diameters of the negative active material 10 include Dᵥ₁₀. The particle diameter Duo of the negative active material 10 and the length L1 of the conductive carbon fiber tube 20 satisfy: 0.8≤L1/Dᵥ₁₀≤6. For example, L1/Dᵥ₁₀ may be 0.8, 1.0, 3.0, 4.0, 5.0, 6.0, or a value falling within a range formed by any two thereof. Dᵥ₁₀ is a particle diameter corresponding to a cumulative volume distribution percentage 10% of the negative active material 10 in a volume-based particle size distribution curve. Controlling the particle diameter Duo of the negative active material 10 and the length L1 of the conductive carbon fiber tube 20 to fall within the range of 0.8≤L1/Dᵥ₁₀≤6 helps to maintain the length of the conductive carbon fiber tube 20 within the desired range, and prevents the conductive carbon fiber tube 20 from being excessively short relative to the negative active material 10 particles (that is, L1/Dᵥ₁₀ is lower than 0.8 as a lower limit). The excessively short length makes the conductive carbon fiber tube 20 fail to exert a long-range conduction effect. Alternatively, the above range prevents the conductive carbon fiber tube 20 from being excessively long relative to the negative active material 10 particles (that is, L1/Dᵥ₁₀ is higher than 6 as an upper limit) and entangling. The excessively long length also weakens the long-range conduction effect of the conductive carbon fiber tube 20, and makes the negative electrode slurry hardly processible.

In some exemplary embodiments, the particle diameter Duo of the negative active material 10 satisfies: 2 μm≤Dᵥ₁₀≤9 μm. For example, Dᵥ₁₀ may be 2 μm, 3 μm, 5 μm, 7 μm, 9 μm, or a value falling within a range formed by any two thereof. With the particle diameter Dᵥ₁₀ of the negative active material 10 falling within the range of 2 μm≤Dᵥ₁₀≤9 μm, the reaction area of the negative active material 10 can be adjusted to a suitable range to prolong the service life of the negative electrode plate, and can also prevent the negative active material 10 from agglomerating and deteriorating the charge-and-discharge efficiency of the negative electrode plate.

In some exemplary embodiments, based on a mass of the negative active material layer, the mass percentage of the negative active material 10 is A, and A satisfies: 94.0%≤A≤ 98.6%. For example, A may be 94.0%, 95.1%, 95.6%, 97.8%, 98.6%, or a value falling within a range formed by any two thereof.

In some exemplary embodiments, based on a mass of the negative active material layer, the mass percentage of the conductive carbon fiber tube 20 is B, and B satisfies: 0.1%≤ B≤3.0%. For example, B may be 0.1%, 0.8%, 1.8%, 2.5%, 3.0%, or a value falling within a range formed by any two thereof.

In some exemplary embodiments, based on a mass of the negative active material layer, the mass percentage of the linear binder 30 is C, and C satisfies: 0.5%≤C≤3.0%. For example, C may be 0.5%, 0.8%, 1.4%, 2.2%, 3.0%, or a value falling within a range formed by any two thereof.

In some exemplary embodiments, B and C satisfy: 0.1≤B/C≤1.5. For example, B/C may be 0.1, 0.5, 0.8, 1.0, 1.2, 1.5, or a value falling within a range formed by any two thereof. With the mass ratio between the conductive carbon fiber tube 20 and the linear binder 30 falling within 0.1≤B/C≤1.5, the conductivity and the cohesive force of the negative active material layer can be improved and controlled within a suitable range. In addition, the distribution range of the linear binder 30 adsorbed on the surface of the conductive carbon fiber tube 20 is made suitable, so that the conductive carbon fiber tube 20 provides a suitable surface area for contact with the adjacent conductive material to construct a three-dimensional conductive network. In addition, the mass ratio falling within the above range also improves the processing performance of the conductive slurry of the negative electrode. When B/C is lower than the lower limit, the content of the linear binder 30 is excessively high, so that the linear binder 30 is prone to cover an excessively large area of the conductive carbon fiber tube 20, thereby being adverse to the connection between the conductive carbon fiber tube 20 and the adjacent conductive material, and also bringing an adverse effect of reducing the conductivity of the conductive carbon fiber tube 20. When B/C is higher than the upper limit, the content of the linear binder 30 is insufficient, thereby resulting in an insufficient cohesive force of the negative active material layer, making the active material prone to be detached, and also bringing an adverse effect of sedimentation of the conductive slurry of the negative electrode during processing.

In some exemplary embodiments, the weight-average molecular weight of the linear binder 30 is M_{w}. M_{w} satisfies: 8×10⁵≤M_{w}≤25×10⁵. For example, M_{w} may be 8×10⁵, 13×10⁵, 18×10⁵, 20×10⁵, 25×10⁵, or a value falling within a range formed by any two thereof. The weight-average molecular weight M_{w} of the linear binder 30 falls within the range of 8×10⁵≤M_{w}≤25×10⁵, so that the linear binder 30 can play a good bonding role to bond to other materials in the negative active material layer, improve the cohesive force of the negative active material layer, and alleviate the problem of easy detachment of the active material from the negative active material layer. In addition, the linear binder 30 bonds the conductive carbon fiber tube 20 to other materials, thereby improving the stability of the three-dimensional conductive network constructed by the conductive carbon fiber tube 20. When the weight-average molecular weight M_{w} of the linear binder 30 is lower than 8×10⁵ as a lower limit, the adhesion force of the linear binder 30 tends to be insufficient, and adversely the conductive slurry of the negative electrode is prone to deposit more sediment. When the weight-average molecular weight M_{w} of the linear binder 30 is higher than 25×10⁵ as an upper limit, the linear binder 30 is prone to get entangled and occupy space. When applied in an electrochemical device, such a negative electrode plate is prone to cause a decrease in the energy density of the electrochemical device, and make the viscosity of the conductive slurry of the negative electrode excessively high and worsen the coating process adversely.

In some exemplary embodiments, the linear binder 30 is at least one selected from the group consisting of a carboxymethyl cellulose salt, polyacrylic acid, a polyacrylate salt, a polyacrylate ester, and polyimide. The carboxymethyl cellulose salt is at least one selected from the group consisting of sodium carboxymethyl cellulose and lithium carboxymethyl cellulose. The polyacrylate salt is at least one selected from the group consisting of sodium polyacrylate and lithium polyacrylate.

In some exemplary embodiments, the negative active material layer further includes a particulate binder. The particulate binder bonds to the negative active material 10 and the functional material. Specifically, the particulate binder may be connected to at least one of the conductive carbon fiber tube 20 or the linear binder 30. The particulate binder 40 further strengthens the cohesive force inside the negative active material 10, and strengthens the stability of the three-dimensional conductive network. The particulate binder in an embodiment of this application is sheet-shaped in the negative active material layer, and differs from the linear binder 30 in that the linear binder 30 is in the shape of a long chain and the particulate binder 40 is in the shape of a sheet with a relatively small length-to-width ratio. The negative active material 10 undergoes a volume change during charge and discharge, and the particulate binder 40 can play a damping role to suppress the volume change of the negative active material 10, thereby alleviating the debonding and peel-off of the negative active material 10 and prolonging the service life of the electrochemical device.

In some exemplary embodiments, the particulate binder is at least one selected from the group consisting of styrene-butadiene rubber and poly(styrene-co-butadiene).

In some exemplary embodiments, based on a mass of the negative active material layer, the mass percentage of the particulate binder is E, and E satisfies: 0%<E≤2.0%. For example, E may be 0%, 0.1%, 0.5%, 1.5%, 2.0%, or a value falling within a range formed by any two thereof.

The negative electrode plate further includes a negative current collector. The negative active material layer is connected to the surface of the negative current collector. Specifically, the negative current collector includes two surfaces opposite to each other in the thickness direction of the current collector. The negative active material layer is connected to at least one of the two surfaces of the negative current collector. The particulate binder 40 and the linear binder 30 can also be connected to the surface of the negative current collector to enhance the stability of the negative active material layer connected to the surface of the negative current collector.

In some exemplary embodiments, a pressure resistance F1 exists between the negative active material layer and the negative current collector, and F1 satisfies: 30 kg/m≤F1≤90 kg/m. For example, F1 may be 30 kg/m, 40 kg/m, 50 kg/m, 70 kg/m, 80 kg/m, 90 kg/m, or a value falling within a range formed by any two thereof. The pressure resistance can reflect the ability of the negative electrode plate to prevent active material detachment and debonding during compaction. The pressure resistance falling within the range of 30 kg/m≤F1≤90 kg/m endows the electrode plate with a high ability to prevent active material detachment and debonding.

The cohesive force can reflect the interaction force between the materials inside the negative active material layer. The greater the cohesive force, the greater the interaction force between the materials inside the negative active material layer, and the less likely the negative active material layer is to shed the active material. In some exemplary embodiments, the negative active material layer possesses a cohesive force F2, and F2 satisfies: 15 N/m≤F2≤ 60 N/m. For example, F2 may be 15 N/m, 30 N/m, 40 N/m, 50 N/m, 60 N/m, or a value falling within a range formed by any two thereof.

The negative current collector is not particularly limited herein as long as the objectives of this application can be achieved. In some embodiments, the negative current collector includes, but is not limited to, a copper foil, a nickel foil, a stainless steel foil, a titanium foil, foamed nickel, foamed copper, a conductive-metal-clad polymer substrate, or any combination thereof. In some embodiments, the negative current collector is copper foil.

In some embodiments, the structure of the negative electrode plate is a negative electrode structure well-known in the art for use in an electrochemical device.

An embodiment of this application further provides an electrochemical device. The electrochemical device may be a lithium-ion battery or any other appropriate electrochemical device. To the extent not departing from the content disclosed herein, the electrochemical device according the embodiments of this application includes any device in which an electrochemical reaction occurs. Specific examples of the electrochemical device include all kinds of primary batteries, secondary batteries, fuel cells, solar cells, or capacitors. In particular, the electrochemical device is a lithium secondary battery. The types of the lithium secondary battery include, but are not limited to, a lithium metal secondary battery, a lithium-ion secondary battery, a lithium polymer secondary battery, or a lithium-ion polymer secondary battery.

The electrochemical device of this application includes a positive electrode plate and a negative electrode plate. The positive electrode plate contains a positive active material capable of retaining and releasing metal ions. The negative electrode plate contains a negative active material 10 capable of retaining and releasing metal ions. A main characteristic of the electrochemical device is that the electrochemical device includes any of the negative electrodes disclosed herein above.

The electrochemical device of this application further includes a negative tab, a positive tab, a separator, an electrolyte solution, and an outer package. The positive tab is disposed on the positive electrode plate. The negative tab is disposed on the negative electrode plate. The separator is disposed between the positive electrode plate and the negative electrode plate. The positive electrode plate, the separator, and the negative electrode plate are stacked alternately to form a stacked-type electrode assembly, or, the positive electrode plate, the separator, and the negative electrode plate are stacked alternately and then wound to form a jelly-roll electrode assembly. The electrode assembly is placed in the internal space of the outer package. The positive tab and the negative tab are led out from the internal space of the outer package and electrically connected to an external circuit. The electrolyte solution fills the internal space of the outer package.

The positive electrode plate, negative tab, positive tab, separator, electrolyte solution, and outer package are not particularly limited herein, and may be made of any materials applicable to this field.

The positive electrode plate includes a positive current collector and a positive active material layer disposed on the surface of the positive current collector. The positive electrode plate is not particularly limited herein. The positive active material layer includes a positive active material. The positive active material is not particularly limited herein as long as the objectives of this application can be achieved. For example, the positive active material includes a compound that enables reversible intercalation and deintercalation of lithium ions (that is, a lithiated intercalation compound). In some embodiments, the positive active material may include a lithium transition metal composite oxide. The lithium transition metal composite oxide contains lithium and at least one selected from the group consisting of elements cobalt, manganese, and nickel. In some embodiments, the positive active material is at least one selected from the group consisting of lithium cobalt oxide (LiCoO₂), lithium nickel-cobalt-manganese ternary material (NCM), lithium manganese oxide (LiMn₂O₄), lithium nickel manganese oxide (LiNi_{0.5}Mn_{1.5}O₄), and lithium iron phosphate (LiFePO₄).

In some embodiments, the positive active material layer further includes a binder. The binder can strengthen bonding between particles of the positive active material, and strengthen bonding between the positive active material and the positive current collector. In some embodiments, the binder includes, but is not limited to, polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene butadiene rubber, acrylic (acrylated) styrene butadiene rubber, epoxy resin, nylon, and the like.

In some embodiments, the positive active material layer optionally further includes a conductive material, thereby imparting conductivity to the positive active material layer. The conductive material may include any conductive material that does not cause a chemical change. Examples of the conductive material include, but are not limited to, a carbon-based material (for example, natural graphite, artificial graphite, carbon black, acetylene black, Ketjen black, and carbon fiber), a metal-based material (for example, metal powder or metal fiber containing copper, nickel, aluminum, silver, and the like), a conductive polymer (for example, a polyphenylene derivative), and any mixture thereof.

In some embodiments, the positive current collector is a metal. The metal may be, but is not limited to, aluminum foil.

In some embodiments, the structure of the positive electrode plate is a positive electrode structure well-known in the art for use in an electrochemical device.

The separator applicable to some embodiments of this application may be a separator known in the prior art. The separator is insulative. The insulative separator is made of a polymer film, a multilayer polymer film, or a nonwoven fabric, which, in each case, is formed by any one of the following polymers or by a composite of two or more of the following polymers: polyethylene, polypropylene, polyethylene terephthalate, polyphthalamide, polybutylene terephthalate, polyester, polyacetal, polyamide, polycarbonate ester, polyimide, polyether ether ketone, polyaryl ether ketone, polyetherimide, polyamideimide, polybenzimidazole, polyethersulfone, polyphenylene ether, cycloolefin copolymer, polyphenylene sulfide, or polyethylene naphthalene. The polyethylene includes constituents that are at least one selected from the group consisting of high-density polyethylene, low-density polyethylene, and ultra-high-molecular-weight polyethylene.

The electrolyte solution applicable to some embodiments of this application may be an electrolyte solution known in the prior art. The electrolyte solution may be classed into aqueous electrolyte solutions and nonaqueous electrolyte solutions. In contrast with an aqueous electrolyte solution, an electrochemical device that adopts a nonaqueous electrolyte solution can operate in a wider voltage window, thereby achieving a higher energy density. In some embodiments, the nonaqueous electrolyte solution includes an organic solvent, an electrolyte, and an additive.

The electrolyte applicable to the electrolyte solution according to an embodiment of this application includes, but is not limited to: an inorganic lithium salt, for example, LiClO₄, LiAsF₆, LiPF₆, LiBF₄, LiSbF₆, LiSO₃F, LiN(FSO₂)₂, or the like; a fluorine-containing organic lithium salt, for example, LiCF₃SO₃, LiN(FSO₂)(CF₃SO₂), LiN(CF₃SO₂)₂, LiN(C₂FsSO₂)₂, cyclic lithium 1,3-hexafluoropropane disulfonimide, cyclic lithium 1,2-tetrafluoroethane disulfonimide, LiPF₄(CF₃)₂, LiN(CF₃SO₂)(C₄F₉SO₂), LiC(CF₃SO₂)₃, LiPF₄(CF₃SO₂)₂, LiPF₄(C₂F₅)₂, LiPF₄(C₂FsSO₂)₂, LiBF₂(CF₃)₂, LiBF₂(C₂F₅)₂, LiBF₂(CF₃SO₂)₂, or LiBF₂(C₂FsSO₂)₂; a lithium salt containing a dicarboxylic acid coordination complex, for example, lithium bis(oxalato)borate, lithium difluoro(oxalato)borate, lithium tris(oxalato)phosphate, lithium difluorobis(oxalato)phosphate, or lithium tetrafluoro(oxalato)phosphate, or the like. In addition, a single one of the foregoing electrolytes may be used separately, or two or more thereof may be used simultaneously. For example, in some embodiments, the electrolyte includes a combination of LiPF₆ and LiBF₄. In some embodiments, the electrolyte includes LiPF₆.

In some embodiments, a concentration of the electrolyte is within a range of 0.8 mol/L to 3 mol/L, for example, within a range of 0.8 mol/L to 2.5 mol/L, within a range of 0.8 mol/L to 2 mol/L, within a range of 1 mol/L to 2 mol/L, or, for another example, the concentration of the electrolyte is 1 mol/L, 1.15 mol/L, 1.2 mol/L, 1.5 mol/L, 2 mol/L, or 2.5 mol/L.

The additives applicable to the electrolyte solution hereof may be additives well-known in the art as able to improve the electrochemical performance of the battery. In some embodiments, the additives include, but are not limited to, at least one of a polynitrile compound, a sulfur-containing additive, fluoroethylene carbonate (FEC), 1,3-propane sultone (PS), or 1,4-butane sultone.

The organic solvent in the electrolyte solution in an embodiment of this application may be any organic solvent known in the prior art. In some embodiments, the organic solvent includes, but is not limited to, a carbonate ester compound, an ester-based compound, an ether-based compound, a ketone-based compound, an alcohol-based compound, an aprotic solvent, or any combination thereof. Examples of the carbonate ester compound include, but are not limited to, a chain carbonate ester compound, a cyclic carbonate ester compound, a fluorocarbonate ester compound, or any combination thereof.

In some embodiments, the organic solvent includes at least one of ethylene carbonate (EC), propylene carbonate (PC), diethyl carbonate (DEC), ethyl methyl carbonate (EMC), dimethyl carbonate (DMC), propylene carbonate, methyl acetate, or ethyl propionate.

This application provides an electronic device. The electronic device includes the electrochemical device described above.

The negative electrode plate according to an embodiment of this application can improve the kinetic performance of the electrochemical device, so that the electrochemical device manufactured by using the negative electrode plate is suitable for electronic devices in various fields, especially for electronic devices that are required to work under conditions of high-rate charging.

The uses of the electrochemical device according to this application are not particularly limited, and the electrochemical device may be used in any electronic device known in the prior art. For example, the electronic devices include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like. In addition, the electrochemical device according to this application is not only applicable to the electronic devices enumerated above, but also applicable to energy storage stations, marine transport vehicles, and air transport vehicles. The air transport vehicles include air transport vehicles in the atmosphere and space transport vehicles outside the atmosphere.

The following describes this application in more detail with reference to specific embodiments and comparative embodiments by using a lithium-ion battery as an example. However, this application is not limited to such embodiments, and covers any implementation solutions that do not depart from the essence of this application. Unless otherwise expressly specified, reagents, materials, and instruments used in the following embodiments and comparative embodiments are all commercially available or obtained by synthesis.

The performance of the lithium-ion battery in the embodiments and comparative embodiments of this application is tested by using the following methods.

### 1. Method for Testing the Length, Inner Diameter, and Outer Diameter of the Conductive Carbon Fiber Tube 20

(1) A finished battery is disassembled to obtain a negative electrode plate.

(2) The negative electrode plate is soaked in dimethyl carbonate (DMC) at 25° C. for 60 minutes to remove the electrolyte solution, and then taken out and air-dried in a 25° C. environment.

(3) The negative electrode plate in step (2) is snapped off by liquid nitrogen to obtain a cross-section of the negative active material layer on the negative electrode plate.

(4) The cross-section of the negative active material layer obtained in step (3) is observed in a scanning electron microscope (SEM), and the length, inner diameter, and outer diameter of at least 15 pieces of target materials are tested at 5 or more different positions, and the measured values are averaged out to obtain a target value.

### 2. Method for Testing the Folding and Entangling of the Conductive Carbon Fiber Tube 20

(1) A finished battery is disassembled to obtain a negative electrode plate.

(2) The negative electrode plate is soaked in DMC at 25° C. for 60 minutes, and then taken out and air-dried in a 25° C. environment.

(3) The negative electrode plate in step (2) is snapped off by liquid nitrogen to obtain a cross-section of the negative active material layer on the negative electrode plate.

(4) The cross-section of the negative active material layer obtained in step (3) is observed in an SEM, and at least 15 pieces of target materials are tested at 5 or more different positions. If the stretched state of the conductive carbon fiber tube 20 exists, three points on the same conductive carbon fiber tube 20 along the length direction of the tube are selected consecutively and connected into a polyline to form a first angle α at a middle point as a vertex, satisfying: 30°≤α≤ 180°, and the carbon fiber tube is the non-entangled conductive carbon fiber tube 20 of this application.

### 3. Method for Testing the Functional Groups and the Weight-Average Molecular Weight of the Binder

(1) A finished battery is disassembled to obtain a negative electrode plate.

(2) The negative electrode plate is soaked in DMC at 25° C. for 60 minutes, and then taken out and air-dried in a 25° C. environment.

(3) The negative electrode plate in step (2) is soaked in a solvent (deionized water, methyl pyrrolidone, or the like) until the negative active material layer falls off, and then the current collector is taken out, and the solution is stirred again to make the negative active material layer fully dissolved in the solvent to obtain a uniformly dispersed suspension.

(4) The suspension in step (3) is placed in a centrifuge, and centrifuged at 3000 r/min for 10 minutes, and a supernatant is taken so that a binder is obtained.

Infrared spectroscopy (IR) is performed to analyze the binder obtained in step (4), and it is determined whether the infrared spectrum of the binder contains peaks of a carboxyl group and an amino group.

The weight-average molecular weight of the binder in step (4) is measured by using gel permeation chromatography (GPC).

### 4. Method for Testing the Cohesive Force

(1) A finished battery is disassembled to obtain a negative electrode plate.

(2) The negative electrode plate is soaked in DMC at 25° C. for 60 minutes, and then taken out and air-dried in a 25° C. environment.

(3) The cohesive force of the negative electrode in step (2) is measured by a 90° angle method by using a GoTech tensile machine. The specific steps are as follows:
a. Make the negative electrode plate into strips. In each strip, the side with the negative active material layer faces up, and the other side is stuck to a steel sheet along the length direction by using double-sided tape.
b. Use the central region on the surface of the negative active material layer facing upward as a steady region, stick adhesive tape onto the surface of the steady region, and leave a blank end 5 cm long.
c. Fix the steel sheet to a corresponding position of the GoTech tensile machine, put the blank end between the grips of the tensile machine and tighten; start the test with the GoTech tensile machine when the tensile force of the grips is greater than 0 kgf and less than 0.02 kgf; stretch the electrode plate at a tensile speed of 5 mm/min until the electrode plate is fractured, and finally record the average tensile force value in the steady region as the cohesive force of the target interface. Especially, the ratio of the standard deviation of the cohesive force data in the steady region to the average value is required not to exceed 10%.

### 5. Method for Testing the Pressure Resistance

(1) A finished battery is disassembled to obtain a negative electrode plate.

(2) The negative electrode plate is soaked in DMC at 25° C. for 60 minutes, and then taken out and air-dried in a 25° C. environment.

(3) In a 25° C. environment, the negative electrode plate in step (2) is placed between a pair of cold-pressing wheels of 700 mm in diameter and 750 mm in length. In other words, the cold-pressing wheels are disposed on two opposite sides of the negative electrode plate in the thickness direction of the electrode plate, and the width direction of the negative electrode plate is parallel to the length of the cold-pressing wheels. The two cold-pressing wheels are rotated to move synchronously along the length direction of the negative electrode plate. A specified pressure is applied to the cold-pressing wheels to squeeze the negative electrode plate until the negative active material layer is detached from the negative electrode plate. The pressure applied by the cold-pressing wheels to the negative electrode plate is the pressure resistance.

### 6. Method for Testing the 25° C. And 2.0c Charge Rate

(1) A finished battery with a full charge voltage of 4.50 Vis left to stand at 25±2° C. for 2 hours, and then discharged at 0.5 C until the voltage drops to 3.0 V, and then left to stand for 5 minutes.

(2) The battery is charged at 2.0 C until the voltage reaches 4.50 V. The charge capacity at this step is recorded as C1.

(3) The battery is charged at a constant voltage of 4.50 V until the current drops to 0.025 C. The charge capacity in this step is recorded as C2.

The 25° C. and 2.0 C charge rate of the battery is C1/(C1+C2)×100%.

### 7. Method for Testing the Thickness Expansion Rate of the Battery Charged and Discharged for 500 Cycles

The following process is performed at 45° C.:

(1) A finished battery is left to stand for 2 hours, and then discharged at 0.5° C. until the voltage drops to 3.0 V, and then charged at 0.5 C until a cut-off voltage of 4.50 V indicating a full charge state, and discharged at 0.5 C until the voltage drops to 3.0 V, and then left to stand for 5 minutes.

(2) The battery is charged at 2.0 C until the voltage reaches 4.30 V, and then charged at 4.30 V until the current drops to 1.0 C.

(3) The battery is charged again at 1.0 C until the voltage reaches 4.40 V, and then charged at a voltage of 4.40 V until the current drops to 0.7 C.

(4) The battery is charged at a current of 0.7 C until the voltage reaches 4.50 V, and then charged at a voltage of 4.50 V until the current drops to 0.025 C, and then left to stand for 5 minutes.

(5) The battery is discharged at a current of 0.5 C until the voltage drops to 3.0 V.

(6) The steps of (2) to (5) are a charge-and-discharge cycle. Steps (2) to (5) are repeated for 50 cycles. In the 50th cycle, the battery is charged at a current of 0.5 C until the voltage reaches 4.5 V, and then charged at a voltage of 4.5 V until the current drops to 0.025 C, and then left to stand for 5 minutes. Subsequently, the thickness of the battery is measured, and then the battery is discharged at a current of 0.5 C until the voltage reaches 3.0 V.

(7) Steps (2) to (6) are repeated 10 times.

Thickness expansion rate: A fully charged battery in step (1) is placed in a 25±2° C. environment, and then the thickness of the battery is measured at the point where the positive tab is attached, denoted as T1. The battery in step (7) that is fully charged to 4.30 V after being charged and discharged for 500 cycles is placed in a 25±2° C. environment. The thickness of the battery is measured at the point where the positive tab is attached, denoted as T500.

The thickness expansion rate of the battery charged and discharged for 500 cycles is: (T500−T1)/T1×100%.

### Embodiment 1-1

### I. Preparing a Lithium-Ion Battery

### 1. Preparing a Negative Electrode Plate

A linear binder is dissolved in deionized water until the solid content reaches 5%, and then stirred until the binder is dispersed evenly to form a gel solution. 40% of the total content of the gel solution is mixed with graphite as a negative active material and conductive carbon fibers, and stirred well and kneaded together. Subsequently, the remaining gel solution, a particulate binder, and an appropriate amount of deionized water are added to form a negative active layer slurry in which the solid content is 50%. After the slurry is stirred well, the slurry is applied onto a 5 μm-thick copper foil, and dried to form a negative electrode plate.

### 2. Preparing a Positive Electrode Plate

Lithium cobalt oxide as a positive active material, acetylene black as a conductive agent, carbon nanotubes as another conductive agent, polyvinylidene difluoride (PVDF) as a binder are mixed at a mass ratio of 97.5:0.7:0.5:1.3 in an N-methyl-pyrrolidone (NMP) solvent, and stirred well with a vacuum mixer to obtain a positive electrode slurry in which the solid content is 70 wt %. The positive electrode slurry is applied onto a 9 μm-thick positive current collector aluminum foil, oven-dried and cold-pressed to form a positive active material layer that is approximately 75 μm in thickness, and then the coated current collector is cut into the desired size, and tabs are welded to obtain a positive electrode plate.

### 3. Preparing an Electrolyte Solution

Ethylene carbonate (EC), propylene carbonate (PC), ethyl methyl carbonate (EMC), and diethyl carbonate (DEC) are mixed well in a dry argon atmosphere glovebox at a mass ratio of EC:PC:EMC:DEC=10:25:35:30, and then fluoroethylene carbonate is added at a mass fraction of 2% and dissolved and stirred well, and then a lithium salt LiPF₆ is added and mixed well to obtain an electrolyte solution. In the electrolyte solution, the concentration of the LiPF₆ is 1 mol/L.

### 4. Preparing a Separator

A 5 μm-thick polypropylene film is used as a separator.

### 5. Preparing a Lithium-Ion Battery

The resultant positive electrode plate, separator, and negative electrode plate are stacked in sequence. A positive tab is mounted onto the positive electrode plate, and a negative tab is mounted onto the negative electrode plate. The separator is located between the positive electrode plate and the negative electrode plate to serve a function of separation, and then the stacked structure is wound to obtain an electrode assembly. The electrode assembly is placed in an aluminum laminated film foil as an outer package, and the electrolyte solution is injected into the outer package. The steps such as vacuum packaging, static standing, and chemical formation are performed to obtain a lithium-ion battery.

With respect to the preparation of the negative electrode plate, the following embodiments and comparative embodiments mainly differ in the parameters of the material of the negative electrode plate. Table 1 shows the relevant performance parameters of the negative electrode plates in Comparative Embodiment 1-1 to 1-2 and Embodiments 1-1 to 1-18, and the performance of the corresponding lithium-ion batteries.

In the negative active material layer in Embodiment 1-1, based on a mass of the negative active material layer, the mass percentage A of the negative active material 10 is 97.7%, the mass percentage B of the conductive carbon fiber tube 20 is 0.3%, the mass percentage C of the linear binder 30 is 1.2%, and the mass percentage E of the particulate binder 40 (styrene-butadiene rubber (SBR)) is 0.8%.

Embodiments 1-2 to 1-18 and Comparative Embodiments 1-1 to 1-3 differ from Embodiment 1-1 in the parameters of the negative active material layer. The relevant parameters are specifically shown in Table 1.

TABLE 1

| | | | | | | | Linear binder | |
|---|---|---|---|---|---|---|---|---|
| | Conductive carbon fiber tube 20 | | | | | | | Weight-average |
| | Outer | Length | Gravimetric | | Inner | | | molecular |
| | diameter | L1 | capacity S | Resistivity | diameter | | | weight Mw |
| Embodiment | D1 (nm) | (μm) | (mAh/g) | ρ (mΩ · cm) | D2 (nm) | Angle α | Type | (×10,000) |
| Embodiment 1-1 | 50 | 8 | 180 | 15 | 6 | 164° | Polyacrylic acid | 200 |
| Embodiment 1-2 | 30 | 8 | 180 | 15 | 1 | 120° | Polyacrylic acid | 200 |
| Embodiment 1-3 | 80 | 8 | 180 | 15 | 12 | 170° | Polyacrylic acid | 200 |
| Embodiment 1-4 | 130 | 8 | 180 | 15 | 30 | 178° | Polyacrylic acid | 200 |
| Embodiment 1-5 | 50 | 2 | 180 | 15 | 6 | 176° | Polyacrylic acid | 200 |
| Embodiment 1-6 | 50 | 15 | 180 | 15 | 6 | 150° | Polyacrylic acid | 200 |
| Embodiment 1-7 | 50 | 30 | 180 | 15 | 6 | 80° | Polyacrylic acid | 200 |
| Embodiment 1-8 | 50 | 50 | 180 | 15 | 6 | 30° | Polyacrylic acid | 200 |
| Embodiment 1-9 | 50 | 8 | 120 | 30 | 6 | 156° | Polyacrylic acid | 200 |
| Embodiment 1-10 | 50 | 8 | 250 | 7 | 6 | 171° | Polyacrylic acid | 200 |
| Embodiment 1-11 | 50 | 8 | 300 | 5 | 6 | 173° | Polyacrylic acid | 200 |
| Embodiment 1-12 | 50 | 8 | 180 | 15 | 6 | 164° | Polyimide | 200 |
| Embodiment 1-13 | 50 | 8 | 180 | 15 | 6 | 164° | Polyacrylic ester | 200 |
| Embodiment 1-14 | 50 | 8 | 180 | 15 | 6 | 164° | Polyacrylic acid | 80 |
| Embodiment 1-15 | 50 | 8 | 180 | 15 | 6 | 164° | Polyacrylic acid | 150 |
| Embodiment 1-16 | 50 | 8 | 180 | 15 | 6 | 164° | Polyacrylic acid | 250 |
| Embodiment 1-17 | 50 | 8 | 180 | 15 | 6 | 164° | Polyacrylic acid | 200 |
| Embodiment 1-18 | 50 | 8 | 180 | 15 | 6 | 164° | Polyacrylic acid | 200 |
| Comparative | No conductive carbon fiber tube 20 | | | | | | Polyacrylic acid | 200 |
| Embodiment 1-1 | | | | | | | | |
| Comparative | 50 | 8 | 180 | 15 | 6 | 164° | No linear binder. Particulate SBR | |
| Embodiments 1-2 | | | | | | | only | |
| Comparative | No conductive carbon fiber tube 20 | | | | | | No linear binder. Particulate SBR | |
| Embodiments 1-3 | | | | | | | only | |
| Comparative | 50 | 60 | 180 | 15 | 6 | 22° | Polyacrylic acid | 200 |
| Embodiments 1-4 | | | | | | | | |

| | | | | Pressure limit on negative | | | 500^{th}-cycle |
|---|---|---|---|---|---|---|---|
| | Negative active | | | electrode plate without | Cohesive | 25° C. | thickness |
| | material 10 | | | causing active material | force of | and 2.0 C | expansion rate |
| | | Dᵥ₁₀ | L1/ | debonding or detachment | active | charge | of battery tested |
| Embodiment | Type | (μm) | Dᵥ₁₀ | F1 (kg/m) | layer F2 | rate | at 45° C. |
| Embodiment 1-1 | Graphite | 6 | 1.3 | 75 | 30 | 65% | 15% |
| Embodiment 1-2 | Graphite | 6 | 1.3 | 84 | 45 | 69% | 12% |
| Embodiment 1-3 | Graphite | 6 | 1.3 | 70 | 27 | 59% | 18% |
| Embodiment 1-4 | Graphite | 6 | 1.3 | 60 | 22 | 55% | 20% |
| Embodiment 1-5 | Graphite | 2 | 1 | 55 | 19 | 67% | 22% |
| Embodiment 1-6 | Graphite | 6 | 2.5 | 80 | 40 | 67% | 13% |
| Embodiment 1-7 | Graphite | 6 | 5 | \|86 | 48 | 70% | 11% |
| Embodiment 1-8 | Graphite | 9 | 5.6 | 60 | 35 | 65% | 24% |
| Embodiment 1-9 | Graphite | 6 | 1.3 | 75 | 30 | 62% | 15% |
| Embodiment 1-10 | Graphite | 6 | 1.3 | 75 | 30 | 69% | 15% |
| Embodiment 1-11 | Graphite | 6 | 1.3 | 75 | 30 | 69% | 15% |
| Embodiment 1-12 | Graphite | 6 | 1.3 | 79 | 38 | 65% | 12% |
| Embodiment 1-13 | Graphite | 6 | 1.3 | 77 | 35 | 65% | 14% |
| Embodiment 1-14 | Graphite | 6 | 1.3 | 60 | 20 | 65% | 20% |
| Embodiment 1-15 | Graphite | 6 | 1.3 | 67 | 25 | 65% | 21% |
| Embodiment 1-16 | Graphite | 6 | 1.3 | 80 | 40 | 65% | 13% |
| Embodiment 1-17 | Silicon oxide | 2.5 | 3.2 | 71 | 26 | 70% | 20% |
| Embodiment 1-18 | Hard carbon | 6 | 1.3 | 78 | 36 | 61% | 12% |
| Comparative | Graphite | 6 | \ | 23 | 11 | 46% | 27% |
| Embodiment 1-1 | | | | | | | |
| Comparative | Graphite | 6 | 1.3 | 25 | 12 | 60% | 30% |
| Embodiments 1-2 | | | | | | | |
| Comparative | Graphite | 6 | \ | 18 | 8 | 42% | 35% |
| Embodiments 1-3 | | | | | | | |
| Comparative | Graphite | 6 | 10 | 27 | 13 | 62% | 26% |
| Embodiments 1-4 | | | | | | | |

As can be seen from Embodiments 1-1 to 1-18 and Comparative Embodiments 1-1 to 1-4 in Table 1, in some embodiments of this application, by adding the conductive carbon fiber tube 20 and the linear binder 30 in the negative active material layer, the charge rate of the battery is improved, and the thickness expansion rate of the battery is alleviated. As can be seen from Comparative Embodiment 1-2 and Embodiment 1-1, although the conductive carbon fiber tube 20 is added in the negative active material layer but the linear binder 30 is not added. Therefore, the charge rate of the battery is improved, but the thickness expansion rate of the battery is significantly increased.

As can be seen from Embodiments 1-1 to 1-4, with the gradual increase of the outer diameter D1 of the conductive carbon fiber tube 20, the charge rate performance of the battery gradually decreases, and the thickness expansion rate of the battery gradually increases. This is because the specific surface area of the conductive carbon fiber tube 20 decreases after the outer diameter increases. With the mass percentage being constant, the number of conductive carbon fiber tubes 20 decreases, and the network becomes sparse.

As can be seen from Embodiment 1-1 and Embodiments 1-5 to 1-8, with the gradual increase of the length L1 of the conductive carbon fiber tube 20, the first angle α fluctuates between 30° and 180°, the charge rate performance of the battery increases first and then decreases, and the thickness expansion rate of the battery increases first and then decreases. This is because the increased length enhances the long-range conductivity of the conductive carbon fiber tube 20 and the binding effect on the negative active material 10. The increased length also reduces the first angle α. In other words, the degree of bending of the conductive carbon fiber 20 increases, thereby affecting the stretching of the linear binder, and in turn, affecting the cohesive force of the negative active material layer and affecting the expansion of the electrochemical device.

As can be seen from Embodiment 1-1 and Embodiments 1-13 to 1-15, the weight-average molecular weight of the linear binder 30 almost exerts no effect on the charge rate performance of the battery. The larger the weight-average molecular weight of the linear binder 30, the lower the thickness expansion rate of the battery. This is because a larger molecular weight leads to a stronger bonding force.

As can be seen from Embodiment 1-1 and Embodiments 1-16 to 1-18, in the case that the negative active material 10 is made of graphite, a silicon-containing material, and hard carbon, the conductive carbon fiber tube 20 and the chain binder 30 are added in the negative active layer, thereby improving both the charge rate and the thickness expansion rate of the battery.

Embodiments 2-1 to 2-8 differ from Embodiment 1-1 in the contents of the negative active material 10, the conductive carbon fiber tube 20, the linear binder 30, and the particulate binder 40. The specific parameters are shown in Table 2.

TABLE 2

| | | | | | | Pressure limit on | | | 500^{th}-cycle |
|---|---|---|---|---|---|---|---|---|---|
| | | | | | | negative electrode | | | thickness |
| | Mass percentage of each constituent in negative | | | | | plate without | | | expansion |
| | active material layer | | | | | causing active | Cohesive | | rate of |
| | Conductive | | | | | material debonding | force of | 25° C. | battery |
| | carbon fiber | Polyacrylic | Particulate | Graphite | | or detachment F1 | active layer | and 2.0 C | tested at |
| Embodiment | tube 20 B | acid C | binder E | A | B/C | (kg/m) | F2 | charge rate | 45° C. |
| Embodiment | 0.3% | 1.2% | 0.8% | 97.7% | 0.25 | 75 | 30 | 65% | 15% |
| 1-1 | | | | | | | | | |
| Embodiment | 0.1% | 0.8% | 0.5% | 98.6% | 0.13 | 35 | 19 | 70% | 25% |
| 2-1 | | | | | | | | | |
| Embodiment | 0.3% | 1.0% | 0.8% | 97.9% | 0.30 | 70 | 27 | 68% | 18% |
| 2-2 | | | | | | | | | |
| Embodiment | 0.5% | 1.5% | 0.8% | 97.2% | 0.33 | 78 | 34 | 69% | 13% |
| 2-3 | | | | | | | | | |
| Embodiment | 1.0% | 2.0% | 0.0% | 97.0% | 0.50 | 81 | 37 | 71% | 12% |
| 2-4 | | | | | | | | | |
| Embodiment | 3.0% | 3.0% | 0.0% | 94.0% | 1.00 | 83 | 40 | 73% | 11% |
| 2-5 | | | | | | | | | |
| Embodiment | 0.8% | 0.5% | 2.0% | 96.8% | 1.50 | 67 | 25 | 75% | 23% |
| 2-6 | | | | | | | | | |
| Embodiment | 0.2% | 2.5% | 0.0% | 97.3% | 0.08 | 60 | 27 | 50% | 19% |
| 2-7 | | | | | | | | | |
| Embodiment | 0.5% | 0.15% | 0.8% | 98.55% | 3.33 | 30 | 15 | 71% | 25% |
| 2-8 | | | | | | | | | |

The test results in Table 2 show that controlling the mass percentages of the negative active material 10, the conductive carbon fiber tube 20, the linear binder 30, and the particulate binder 40 to fall within appropriate ranges can improve the charge rate and alleviate the thickness expansion rate of the battery.

The ratio of the mass percentage B of the conductive carbon fiber tube 20 to the mass percentage C of the linear binder 30 is controlled within the range of 0.1 to 1.5, thereby achieving good C-rate performance and a low expansion rate. When the B/C ratio exceeds the upper limit 1.5, the expansion rate of the battery deteriorates. This is because the small amount of linear binder 30 exerts a weak binding force on the active material. When the B/C ratio is lower than the lower limit 0.1, the C-rate performance deteriorates. This is because the linear binder 30 coats an excessively large area of the conductive carbon fiber tube 20, and therefore, reduces the conductivity of the conductive carbon fiber tube.

It is hereby noted that this application is not limited to the foregoing embodiments. The foregoing embodiments are merely examples. Any and all embodiments with substantively the same constituents or exerting the same effects as the technical ideas hereof without departing from the scope of the technical solutions of this application still fall within the technical scope of this application. In addition, all kinds of variations of the embodiments conceivable by a person skilled in the art and any other embodiments derived by combining some constituents of the embodiments hereof without departing from the subject-matter of this application still fall within the scope of this application.

What is claimed is:

1. A negative electrode plate comprising a negative active material layer; wherein
the negative active material layer comprises a negative active material and a functional material, the functional material is distributed between particles of the negative active material, the functional material comprises a conductive carbon fiber tube and a linear binder, and the linear binder is adsorbed on a surface of the conductive carbon fiber tube; and
a length of the conductive carbon fiber tube is L1, and 2 μm≤L1≤50 μm; and three points on a same conductive carbon fiber tube along a length direction of the conductive carbon fiber tube are arbitrarily selected and connected into a polyline to form a first angle α at a middle point of the three points as a vertex, satisfying: 30°≤α≤180°.

2. The negative electrode plate according to claim 1, wherein 2 μm≤L1≤30 μm, and 80°≤α≤180°.

3. The negative electrode plate according to claim 1, wherein the conductive carbon fiber tube satisfies at least one of the following conditions:
an outer diameter of the conductive carbon fiber tube is D1, and 30 nm≤D1≤130 nm;
an inner diameter of the conductive carbon fiber tube is D2, and 1 nm≤D2≤30 nm;
a gravimetric capacity of the conductive carbon fiber tube is S, and 120 mAh/g≤S≤300 mAh/g; or
a resistivity of the conductive carbon fiber tube is ρ, and 5 mΩ·cm≤ρ≤30 mΩ·cm.

4. The negative electrode plate according to claim 1, wherein particle diameters of the negative active material comprise Dᵥ₁₀, Dᵥ₁₀ is a particle diameter corresponding to a cumulative volume distribution percentage 10% of the negative active material in a volume-based particle size distribution curve, and the negative active material layer satisfies at least one of the following conditions:
$$\begin{matrix}2 μm \leq {D}_{v 10} \leq 9 μm ; or \\ 0.8 \leq L 1 / {D}_{v 10} \leq 6 .\end{matrix}$$

5. The negative electrode plate according to claim 1, wherein based on a mass of the negative active material layer, a mass percentage of the negative active material is A, a mass percentage of the conductive carbon fiber tube is B, and a mass percentage of the linear binder is C; and the negative active material layer satisfies at least one of the following conditions:
$$\begin{matrix}94. \% \leq A \leq 98.6 \% ; \\ 0.1 \% \leq B \leq 3. \% ; \\ 0.5 \% \leq C \leq 3. \% ; or \\ 0.1 \leq B / C \leq 1.5 .\end{matrix}$$

6. The negative electrode plate according to claim 1, wherein a weight-average molecular weight of the linear binder is M_{w}, and 8×10⁵≤M_{w}≤25×10⁵.

7. The negative electrode plate according to claim 1, wherein
the linear binder is at least one selected from the group consisting of a carboxymethyl cellulose salt, polyacrylic acid, a polyacrylate salt, a polyacrylate ester, and polyimide; and
the negative active material is at least one selected from the group consisting of graphite, hard carbon, and a silicon-containing active material.

8. The negative electrode plate according to claim 1, wherein the negative active material layer further comprises a particulate binder, and the particulate binder is bonded to the negative active material and the functional material;
the particulate binder is at least one selected from the group consisting of styrene-butadiene rubber and poly(styrene-co-butadiene); and
based on the mass of the negative active material layer, a mass percentage of the particulate binder is E, and 0%<E≤2.0%.

9. The negative electrode plate according to claim 1, wherein the negative electrode plate further comprises a negative current collector, and the negative active material layer is connected to a surface of the negative current collector;
a pressure resistance F1 exists between the negative active material layer and the negative current collector, and 30 kg/m≤F1≤90 kg/m; and
the negative active material layer possesses a cohesive force F2, and 15 N/m≤F2≤60 N/m.

10. An electrochemical device, the electrochemical device comprises a negative electrode plate, the negative electrode plate comprising a negative active material layer; wherein
the negative active material layer comprises a negative active material and a functional material, the functional material is distributed between particles of the negative active material, the functional material comprises a conductive carbon fiber tube and a linear binder, and the linear binder is adsorbed on a surface of the conductive carbon fiber tube; and
a length of the conductive carbon fiber tube is L1, and 2 μm≤L1≤50 μm; and three points on a same conductive carbon fiber tube along a length direction of the conductive carbon fiber tube are arbitrarily selected and connected into a polyline to form a first angle α at a middle point of the three points as a vertex, satisfying: 30°≤α≤180°.

11. The electrochemical device according to claim 10, wherein 2 μm≤L1≤30 μm, and
$$80 ° \leq α \leq 180 ° .$$

12. The electrochemical device according to claim 10, wherein the conductive carbon fiber tube satisfies at least one of the following conditions:
an outer diameter of the conductive carbon fiber tube is D1, and 30 nm≤D1≤130 nm;
an inner diameter of the conductive carbon fiber tube is D2, and 1 nm≤D2≤30 nm;
a gravimetric capacity of the conductive carbon fiber tube is S, 120 mAh/g≤S≤300 mAh/g; or
a resistivity of the conductive carbon fiber tube is ρ, and 5 mΩ·cm≤ρ≤30 mΩ·cm.

13. The electrochemical device according to claim 12, wherein the conductive carbon fiber tube satisfies at least one of the following conditions:
an outer diameter of the conductive carbon fiber tube is D1, and 30 nm≤D1≤80 nm;
an inner diameter of the conductive carbon fiber tube is D2, and 1 nm≤D2≤12 nm.

14. The electrochemical device according to claim 10, wherein particle diameters of the negative active material comprise Dᵥ₁₀, Dᵥ₁₀ is a particle diameter corresponding to a cumulative volume distribution percentage 10% of the negative active material in a volume-based particle size distribution curve, and the negative active material layer satisfies at least one of the following conditions:
$$\begin{matrix}2 μm \leq {D}_{v 10} \leq 9 μm ; or \\ 0.8 \leq L 1 / {D}_{v 10} \leq 6 .\end{matrix}$$

15. The electrochemical device according to claim 10, wherein based on a mass of the negative active material layer, a mass percentage of the negative active material is A, a mass percentage of the conductive carbon fiber tube is B, and a mass percentage of the linear binder is C; and the negative active material layer satisfies at least one of the following conditions:
$$\begin{matrix}94. \% \leq A \leq 98.6 \% ; \\ 0.1 \% \leq B \leq 3. \% ; \\ 0.5 \% \leq C \leq 3. \% ; or \\ 0.1 \leq B / C \leq 1.5 .\end{matrix}$$

16. The electrochemical device according to claim 10, wherein a weight-average molecular weight of the linear binder is M_{w}, and 8×10⁵≤M_{w}≤25×10⁵.

17. The electrochemical device according to claim 10, wherein
the linear binder is at least one selected from the group consisting of a carboxymethyl cellulose salt, polyacrylic acid, a polyacrylate salt, a polyacrylate ester, and polyimide; and
the negative active material is at least one selected from the group consisting of graphite, hard carbon, and a silicon-containing active material.

18. The electrochemical device according to claim 10, wherein the negative active material layer further comprises a particulate binder, and the particulate binder is bonded to the negative active material and the functional material;
the particulate binder is at least one selected from the group consisting of styrene-butadiene rubber and poly(styrene-co-butadiene); and
based on the mass of the negative active material layer, a mass percentage of the particulate binder is E, and 0%<E≤2.0%.

19. The electrochemical device according to claim 10, wherein the negative electrode plate further comprises a negative current collector, and the negative active material layer is connected to a surface of the negative current collector;
a pressure resistance F1 exists between the negative active material layer and the negative current collector, and 30 kg/m≤F1≤90 kg/m; and
the negative active material layer possesses a cohesive force F2, and F2 15 N/m≤F2≤60 N/m.

20. An electronic device, wherein the electronic device comprises the electrochemical device according to claim 10.
